(19) United States
(12) Patent Application Publication
(10) Pub. No.: US 2009/0038702 A1
(43) Pub. Date: Feb. 12, 2009

(54) Cost effective repair of piping to increase load carrying capability

(76) Inventors: Edward Robert Fyfe, Del Mar, CA (US); Rodolfo Lorea, Los Angeles, CA (US)

Correspondence Address: GORDON & REES LLP, 101 WEST BROADWAY, SUITE 1600, SAN DIEGO, CA, 92101, US

(21) Appl. No.: 11/891,153

(22) Filed: Aug. 9, 2007

(51) Int. Cl. F16L 55/162

(52) U.S. Cl. 138/98; 138/172; 138/97

(57) ABSTRACT

A pipe repair process that uses low modulus materials with good compressive strength in a compression layer that transfers pressure loads between high modulus repair layers and increases the bending strength of the repaired pipe. Carbon fiber and other fiber reinforced materials are used in the high-modulus layers and low cost and easily applied materials, such as concrete, are utilized in the compression layer.

### FIELD OF THE INVENTION

The repair of existing pipelines is becoming increasingly critical due to the aging infrastructure in this country.

It is known to use fiber reinforced repairs to repair structurally sound but leaking pipe or to use such materials to reinforce weakened pipes that may fail from the pressure of the fluids forced through the pipe. In such a repair the fiber is laid up with resin and adhered to the inner wall of the pipe. Such a method is described in issued U.S. Pat. No. 5,931,198. The present invention is a new technology for accomplishing repairs that is especially useful to repair pipes subject to external loads in addition to internal loads.

### BACKGROUND

All types of pipe including concrete, pre-stressed cylindrical concrete pipe (PCCP) and metal (cast iron and steel), plastic and composite pipe may be damaged by impact, overpressure, corrosion, crushing and similar forces. In addition all types of pipe lose strength over time. Concrete pipe is also subject to damage by fluid intrusion. These changes may impair the pipes ability to withstand internal pressures and may also effect it's ability to withstand external forces such as those imposed by deep burial, location over roadways and load transfer from associated structures (such as bridges). Pipe weaknesses may result in catastrophic failure, partial failure, or the weakness may be discovered during regular inspections before failure. When a failure or incipient failure dictates that the pipe must either repaired or replaced, the pipe must be shut down and therefore all facilities serviced by the pipe are denied service for the duration of the repair. For example, shut down of a water pipe may shut down businesses and make home uninhabitable. For these reasons a repair that can be accomplished in the shortest possible time is desirable.

Especially where the pipe is of sufficient diameter to permit internal access to apply a repair, it is most often cost effective to repair rather than replace the pipe. Although external repair of the pipe can be effective (especially when the pipe is exposed in conjunction with other construction), most repairs must be effected internally by shutting down the pipe and providing access through manholes or a cut opening so that repair can be made to the internal walls of the pipe. If the damage to the pipe is such that it's ability to carry pressure is compromised, the internal repair can become prohibitively expensive due to the large amount of fiber, resin that must be applied, in multiple layers, until sufficient strength is developed. In some instances the thickness of the repair exceeds the original wall thickness of the pipe and becomes cost prohibitive.

Therefore it is desirable to have a cost-effective repair methodology that allows repair of existing pipe even where the ability of the pipe to carry internal pressure is completely compromised.

### SUMMARY OF THE INVENTION

The invention refers to methodologies and materials used in repairing and/or reinforcing pipe. As used herein, a pipe is a conduit for flowable materials (liquid, gaseous or particulate). As such as pipe has an open interior and open ends. The most common configuration for pipe is cylindrical, due to the inherent hoop strength, but other cross-sections are possible and are commonly employed due to space constraints. For example, a square cross-section may be employed for a pipe that is installed in a square opening. In another application, a flat-bottomed, oval shape may be employed in drainage pipes to maximize the flow area while providing good resistance to vertical compression loads, for example, from a road and the vehicles the road carries. The invention is applicable to any shape of pipe, but because of it's superior ability to restore hoop strength in cylindrical pipe, the method is especially useful with and will be described in conjunction making a repair on pipe of that cross-sectional configuration.

The deficiencies of prior repair methods and structures are resolved by the use of the present invention which is a system that utilizes at least two layers of high modulus material. At least one layer is comprised of high modulus fiber reinforced material (one layer may optionally be the original pipe wall) separated by a layer of high compressive strength and relatively low cost material that is bonded to the high modulus layers, whereby the layers collectively contribute beam strength that resists deformation from internal and external pressures without requiring an excessive thickness of fiber reinforced material. The method of the described embodiment is generally applicable to pipes of any diameter but is especially advantageous when used in pipes of 36″ to 144″ in diameter. The fiber reinforced layers and the original pipe wall in good condition are referred to as “high modulus” layers because they have good bending resistance and can absorb high hoop loading (compressive or tensile). In the case where on layer is the wall of the original pipe, the tensile capability for that layer comes from the metal component for example the steel wall in steel pipe). In fiber reinforced materials, the fibers are chosen to have good tensile and good bending strength. The ultimate load the pipe may be subject to determines the thickness of the high modulus fiber reinforced layer. For repairs to PCCP pipes in the 36″ to 144″ inch range the modulus of the FRC material should be in the range of 3,000,000 psi to 80,000,000 psi.

The compressive component must have sufficient strength to transfer loads from internal and external pressures to the high modulus layers. The strength required is in excess of twice the total external and internal hoop loading and is desirably 2.5 times the total loading. The most cost efficient thickness for the compressive component is when the compressive component is in excess of 4 times the thickness of each FRP component and desirably 5 times. Spacing the FRP layers in this manner allows sufficient beam strength to be developed without excessive thickness that would unnecessarily reduce pipe capacity.

The repairs made by the improved method and materials as set forth, result in a high strength repair that is low in cost and which can be applied with a reduced skilled labor content. Repair using the method on the interior of pipes can be made rapidly so that the pipe can be returned to service as quickly as possible.

### BRIEF DESCRIPTION OF THE DRAWINGS

FIG. 1 is a side elevation view showing the application of high compressive strength materials by spraying the material onto the inner surface of the pipe.

FIG. 2 is a cut away cross-sectional view showing the layers in a pipe repaired according to the method and structure of the invention.

### DETAILED DESCRIPTION OF THE ILLUSTRATIVE EMBODIMENT

The present invention is utilized for repairs of fluid carrying pipe. Repairs made on metal reinforced cylindrical concrete Pipe (PCCP) are featured in the exemplary embodiment. However, the method has application to all known pipe materials including plastic, iron, and steel. The pipe is repaired, in part, by the use of fiber reinforced polymer (FRP) materials. The highest ultimate strength present available is achieved using carbon fiber material. When incorporated into a mat and impregnated with resin this material is called Graphite Reinforced Polymer (GRP) or Carbon Fiber Polymer (CFP) material.

FRP materials are normally provided as fabrics with multiple layers having different directional characteristics. For example where the finished material will be subject to loads from all directions, the fiber directions may be uniformly disbursed. Where loads are predictably oriented (such as bending loads longitudinal to the pipe or compressive (radial) loads caused by pressure (external or internal), then a fabric with fibers oriented to provide maximum hoop strength may be employed. Unidirectional fabric is employed as an augment to, or instead of, multi-directional fabric to resist loads that are primarily in one orientation only. As used herein the term fabric is intended to encompass all such variants unless the properties of a specific orientation are particularly called out.

Where the highest strength per unit of thickness and highest durability is required, Carbon Fiber Polymer (CFP) material is the most advantageous type of FRP if the CFP materials will be compatible with the underlying pipe. The disclosed embodiment is described in connection with the use of this material. CFP material is insensitive to most corrosive material that may be found in the fluid stream that will be carried by the repaired pipe. Especially where a single layer of the CFP will be applied it is desirable to use a weft cloth which is laid up with fibers that generally align with the cross section of the pipe to increase the hoop strength of the pipe. Hoop strength can also be achieved by using a spiral winding of narrow width mat or unidirectional fabric would in the hoop direction.

While CFP is preferred in many applications where maximum strength is required, CFP is generally incompatible with metal pipe, so fiberglass FRP is normally used as the initial lay-up in contact with the metal pipe.

The CFP layer may be formed in place with the fiber material being laid up and the resin applied and allowed to polymerize, or partially cured material (sometimes referred to as pre-preg material) can be laid against the tack coat and then allowed to fully polymerize. However, it is often advantageous to at least partially impregnate the material outside the pipe where working conditions and equipment (such as a lay-up table) are conducive to most efficient use of labor. The resin found to be advantageous with the practice of the invention is epoxy resin. Other polymer matrix materials such as urethane have been employed successfully as well.

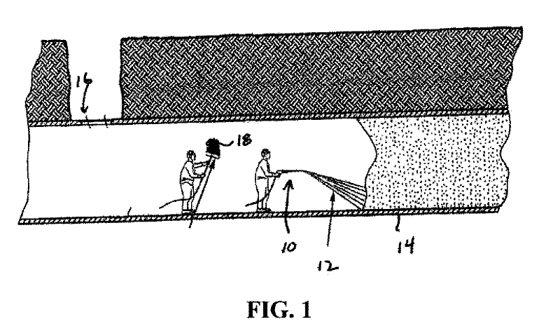

The surface of the pipe is prepared by cleaning and drying the surface. If required, a filler and wet primer may be applied to further prepare the surface. Then a tack coat of adhesive is applied. The tack coat material may desirably by contact cement. FIG. 1 illustrates this step as exemplary of the application of contact cement and other sprayable materials. A spray head 10 is used to apply a tack coat 12 to the pipe 14. Access to the interior of the pipe is gained through manhole 16. In this variation the CFP material 18 is applied while the coat is still tacky (thus the name). This alternative reduces the installation time, because it is not necessary to use inflatable or other forms to hold the CFP material against the surface. The tack coat holds them in place while the material cures. A suitable material for contact cement utilized as a tack coat is rubber epoxy contact cement.

It is especially advantageous in many applications to use a water insensitive, high-strength epoxy on the pipe wall. Such an epoxy can function both as a filler to close cracks an other defects in the pipe wall and as a prime coat to which the CFP reinforcement layer bonds. A suitable epoxy has been found to be TYFO® WP Epoxy.

Where necessary, especially in larger diameter pipe where a large quantity of material will need to be placed overhead, a tack coat of contact cement may be applied over the curing epoxy to hold the CFP material in place until the high strength bond cures.

After the high modulus layer is in place, High compressive material may be applied. The high compressive strength material is selected for compatibility with the fiber reinforced layer, adequate resistance to compression and cost. Suitable materials include concrete, chopped glass fiber, and chopped fiber rubber. These materials have compressive strength in the range of 50 psi to 10,000 psi and are relatively low in material cost. The choice amongst materials is dictated by the total internal pressure and external pressure. The compressive strength should be at least 4.5 and desirably 5 times the total pressure (internal and external) to which the pipe is expected to be exposed. Compressive materials in this range have been found to transfer the compressive stress between the high modulus layers. By being able to use compressive materials at strengths in this range the cost of the materials is reduced. Adding to their cost effectiveness, the enumerated materials can be mixed in a slurry and sprayed on to the high modulus layer by chopper guns or concrete pumps. The primary function of the high compressive layer is to serve as a web in a beam system where the first high modulus layer and the second high modulus layer are spaced by the compressive layer. The higher strength is the result of the higher bending moment created by the larger section properties of the spaced high modulus layers. The high modulus layers and high compressive layer work together to resist external compression and internal pressure. The beam effect causes external point loads to develop tension on the innermost beam element and compression on the outermost layer. The shear forces developed are resisted by the high compressive layer. For these reasons the high compressive layer is bonded to the high modulus layers. Any of the disclosed methods of bonding including contact cement (tack layer) and epoxy adhesive can be used effectively.

The inner most layer is always a fiber reinforced layer and normally will be constructed by the same methods and using the same methods as the first layer. However, particularly where the liquid will be especially corrosive, such as high alkalinity water, a different resin may be selected for known properties in resisting the corrosive content.

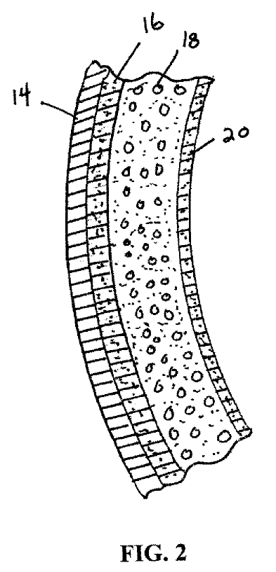

FIG. 2 illustrates the structure of a finished repair in an application that uses two fiber reinforced layers. The pipe 14 has a first FRP layer 16 adhered to the pipe 14. The high compressive layer 18 is applied to the FRP layer 16. In the illustrated example the high compressive layer is concrete. The second high modulus FRP layer 20 is adhered to the high compressive layer 18. It has been found that to make most effective use of the strength of the high cost high modulus layers, the lower cost high compressive layer 18 should be approximately 5 times, or more, the thickness of the outer high modulus layer 20.

Where the condition of the pipe is sufficiently deteriorated that the clean up of the interior surfaces, sufficient to allow good adherence of the first FRP layer, will be unacceptably time consuming, another variant of the invention may be employed. Fiber and resin impregnated material is pressed against the pipe wall by an internal form, such as an inflatable form. The cured layer forms the first high modulus layer and need not be adhered to the pipe. All necessary strength is developed in the fiber and compressive layers. A repair constructed according to this method is referred to as a contact repair because the first fiber layer is merely held against the pipe wall while is resin cures. The repair does not have to rely on the existing pipe for any of it's ability to bear loads. In effect the existing pipe is my be used merely as a passive mold against which the materials are laid up. For this reason contact applications normally require that the ends of the repair extend to, and be sealed against, sections of pipe that have adequate strength and integrity. Sealing the ends prevents liquid from traveling between the inner-most FRP layer and the pipe and reaching sections of the pipe that may not withstand further pressure, or where the liquid, such as water, will further deteriorate the pipe wall.

Where the pipe wall has good residual strength, all or part of the strength of the first high modulus layer may be provided by the pipe wall. If the pipe wall is being relied upon for part of the strength of the first layer, the pipe wall will be bonded to the FRP layer with high strength epoxy such as described above. This option requires that the pipe be cleaned so that the epoxy bonds properly.

If the pipe has sufficient strength to function as the high modulus outer wall, the compressive layer may be bonded directly to the pipe (through primer, where present, and epoxy adhesive). This method is referred to a multi-dimensional because the pipe wall becomes a web in the beam structure.

In all variations, the high compression material functions to transfer internal and external radial loads between the two high modulus layers

While the exemplary embodiment has been described in terms of its use in applying CFP based materials, it may also be used with fabrics comprised of a wide variety of fibers including fibers of glass, polyaramid, boron, Kevlar, silica, quartz, ceramic, polyethylene, and aramid. A wide variety of types of weaves an fiber orientations may be used in the fabric. A primary consideration in the choice of materials will be resistance to the components of the liquid carried in the pipe. For example, if the pipe is used in a drinking water pipeline, the primary consideration of resistance would be water insolubility.

What is claimed is:

1. A method of repairing a pipe that enhance internal pressure carrying capabilities at low cost comprising the steps of:
obtaining access to the interior of the pipe to be repaired, said pipe having a pipe wall;
adhering a layer of high compressive strength material to a first surface secured to said pipe wall;
adhering a layer of fiber reinforced material to said high compressive strength material.

2. The method of claim 1, wherein the steps of adhering a layer of fiber reinforced material comprise:
applying a tack material to said high compressive strength material and then laying up GRP fabric on said tack material.

3. The method of claim 2 wherein:
said step of laying up the GRP material is preceded by impregnating said GRP material with curable resin, and
allowing the resin to cure.

4. The method of claim 2, wherein:
said step of adhering GRP material is followed by impregnating said fabric with curable polymer resin, and
allowing said resin to cure.

5. A method of repairing a pipe that enhance internal pressure carrying capabilities at low cost comprising the steps of:
gaining access to the interior of the pipe to be repaired, said pipe having a pipe wall,
bonding a first layer of FRP fabric to said pipe wall with a high strength bonding agent;
impregnating the FRP fabric with polymer resin, and
allowing the resin to cure so that the pipe wall and said first layer function as a unitary structure;
adhering a layer of high compressive strength material to said first layer of GRP fabric;
adhering a second layer of GRP to said high compressive strength layer.

6. An improved pipe reinforcement structure, for reinforcement of a pipe having a pipe wall, comprising:
a first high modulus layer adhered to or comprising the pipe wall;
an intermediate layer adhered to said first layer and comprising material having high compressive strength;
a second high modulus layer adhered to said intermediate layer and comprising high-modulus, fiber-reinforced and cured resin material.

7. The pipe reinforcement structure of claim 6, wherein:
said high modulus material has a tensile modules in excess of 3,000,000 psi.

8. The pipe reinforcement structure, of claim 6, wherein:
said high compressive strength material has a compressive strength in excess of 2.5 times the total internal and external pressure on the pipe.

9. The pipe reinforcement structure of claim 6, wherein:
the thickness ratio of said intermediate high compressive strength layer to said second high modulus layer is greater than five to one.

10. The pipe reinforcement structure of claim 6, wherein:
said second high modulus layer comprises carbon fibers.

11. A method of reinforcing a pipe that enhances internal pressure carrying and load bearing capabilities at low cost comprising the steps of:
gaining access to the exterior of the pipe to be repaired, said pipe having a pipe wall;
bonding a layer of high compressive strength material to said pipe wall; and
adhering a layer of fiber reinforced material to said high compressive strength layer.

12. The method of claim 11, wherein:
said step of bonding a layer of high compressive strength material is preceded by, bonding a layer of GRP fabric to said pipe wall;
infusing said GRP fabric before or after said fabric is adhered to said pipe wall with polymer resin; and
curing said resin.
